(19) United States
(12) Patent Application Publication
(10) Pub. No.: US 2005/0086231 A1
(43) Pub. Date: Apr. 21, 2005

(54) Information archiving software

(76) Inventor: Alan Moore, Auckland (NZ)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/493,960

(22) PCT Filed: Oct. 31, 2002
(86) PCT No.: PCT/NZ02/00232

(30) Foreign Application Priority Data
Oct. 31, 2001 (NZ) 515148

(51) Int. Cl. G06F 7/00

(52) U.S. Cl. 707/100

(57) ABSTRACT

The present invention is adapted to provide information archiving software for a computer system, where this computer system includes or has access to at least one primary information storage system and an archiving storage system. The software provided is adapted to firstly determine at least one attribute of collections of information or files stored within the primary storage system, and then to subsequently test the attribute or attributes of these collections against at least one predefined rule. Information collections or files with attributes which pass the test or tests applied may then be transferred to the archiving storage system. Preferably, the software provided is implemented through a stand-alone application running in the computer system provided, independent of any file serving functionality.

### TECHNICAL FIELD

This invention relates to software employed to archive, and also preferably retrieve information managed by a computer system or computer systems. Preferably the present invention may be implemented as a stand-alone software application which can be employed within a number of different operating systems and networking architectures.

### BACKGROUND ART

Computers provide powerful information processing and storage tools. Many different types of electronically formatted information may be stored and manipulated using a computer system, either locally on a single computer, or by a number of separate users over a computer network.

Information stored in computer files or computerised documents can accumulate within a computer system or network over time. These files may once have been used frequently but after time can become less important to the daily activities of users. However, such files may still record important information that should be stored on a long-term basis.

To preserve the operational performance of a computer system or network it is preferable to have such historical information or files removed to a secondary archiving facility once they no longer need to be accessed frequently or at high speed. This allows the primary high performance or quick response storage systems of the computer system to be freed up for use with more important or more current information. These historical files can still be stored and retained in lower performance or less accessible data storage hardware as it is unlikely that this information will need to be retrieved quickly.

The archiving of such information becomes an important function within, for example, large file serving systems and networks with large numbers of users. Because of the large numbers and sizes of the documents and files employed, a central file server and associated storage systems can become overloaded with old files which do not necessarily need to be accessed quickly by the system's users. Archiving of computer files in such instances is relatively complicated due to the large numbers of users who may still wish to access such files. Clear rules or requirements for when a file should be archived should be communicated to all users and there must be a degree of agreement between all users regarding when a file should be archived.

One attempt to address these problems is through assigning information storage quotas to users of the system. Users are only allocated a specific set amount of memory or information storage capacity, which forces users to delete or destroy information that is no longer in frequent use. However, this approach can lead to information being destroyed that should in fact be archived within a long-term storage system. Furthermore, users do not necessarily appreciate having such arbitrary quotas or limitations placed on them.

Another attempt to address these problems is through building file archiving functionality into the file server software itself. A designated system administrator for the server can set up a number of archiving rules which allow the server to automatically send files to a secondary archiving or storage system once particular criteria or rules are met.

However, there are some limitations with this approach to file archiving systems. The implementation of such systems within a server is in practice relatively complicated. The system administrators must familiarise themselves with the functionality of such software and the implementation of the archiving rules employed. Furthermore, such file servers which employ archiving functionality are relatively expensive to purchase, and require an in depth understanding of the operation of the server system to be able to set up and maintain both the system and also the archiving functionality it provides.

In addition this type of archiving functionality is implemented with respect to a single file server and operating system only. The archiving functions are built into the file server specific to the particular operating system that the file server is to be run by. No provision is made for archiving of files outside of one particular file server and operating system combination. If the user changes operating systems or server systems they cannot any longer employ such archiving functionality. Furthermore, some operating systems or server software may not supply such archiving functionality, potentially leaving the system's users to manually sort through and archive their collections of files.

An improved file archiving system or software that addressed any or all of the above problems would be of advantage. An archiving system which was simple to use and which could run passively in the background of a computer system to automatically archive selected files, and which also allowed quick and easy retrieval of archived documents would be of advantage. Furthermore, a file archiving system which could be run on a number of different file serving platforms and a number of different operating systems as stand-alone application would be of advantage.

It is an object of the present invention to address the foregoing problems or at least to provide the public with a useful choice.

Further aspects and advantages of the present invention will become apparent from the ensuing description that is given by way of example only.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided information archiving software for a computer system, said computer system including or having access to at least one primary information storage system, and an archiving information storage system, the information archiving software being adapted to execute the steps of:
(i) determining at least one attribute of collections of information stored within a primary information storage system, and
(ii) testing the attribute or attributes of the collections of information stored within the primary information storage system against at least one predefined rule, and
(iii) transferring information collections with associated attributes which pass said at least one test from the primary information storage system to the archiving storage system,
   wherein said information archiving software is implemented as a stand-alone computer application or process independent of any file-serving functionality.

According to a further aspect of the present invention there is provided information archiving software substantially as described above wherein said software is adapted to provide a program run substantially continuously by a computer system.

According to yet another aspect of the present invention there is provided information archiving software substantially as described above said software being adapted to execute the further subsequent step of:
(iv) storing reference stub information within the location of the primary information storage system which the information collection was removed, said reference stub information indicating the location within the archiving information storage system where the transferred information collection is stored.

According to yet another aspect of the present invention there is provided information archiving software substantially as described above further characterised by the additional subsequent step of:
(v) activating retrieval function which employs the stored reference stub information to retrieve and restore an archived information collection to its original location within a primary information storage system.

The present invention is adapted to provide information archiving software. Such software can generally be employed to ensure that information which does not readily need to be accessed frequently or quickly by a user of the system can be removed and stored in an archiving system. This will free system resources for information which does require frequent and fast access.

Furthermore, the present invention may provide an archiving system which can improve the speed which a large computer system can be restored after a crash or failure. As such an archiving system can greatly reduce the size of the primary information storage systems which need to be bought back on line and this in turn reduces the amount of time required to complete this action. With large systems having significant amounts of time critical information, the present invention can provide a major advantage over the prior art.

Reference throughout this specification will also be made to the software employed being loaded within and being run by a computer system. A computer system may encompass an entire network of separate and remote computer processors, or a single stand-alone personal computer or work station. Those skilled in the art should appreciate that the present invention may be adapted to operate in any form of distributed or networked computer system or with a single stand-alone computer if required. However, reference throughout this specification will be made to the present invention being employed within a local area network that also has a central file server operating.

Furthermore, reference throughout this specification will also be made to the present invention providing software installed and run on a single computer system only. However, those skilled in the art should appreciate that a plurality of separate machines may also have a number of instances of the same software installed and running to provide the archiving functions required in accordance with the present invention. Reference to the installation of the software provided on a single computer only should in no way be seen as limiting.

Preferably the computer system may include or have access to at least one primary storage system. A primary storage system can give relatively fast or responsive access to stored information that users require on a frequent basis. A primary storage system may be implemented in any number of ways using current computer hardware and technology. Reference throughout this specification however will be made to a primary storage system being at least one, but preferably a series of high capacity hard discs or hard drives hosted within a central file-serving computer system. For example, a windows based network with shared network drives formed from such hard disks which are available to a plurality of users may form a primary storage system. Such a primary storage system can provide access to the same information to a wide number of users with relatively fast response time.

However those skilled in the art should appreciate that a primary storage system need not necessary be implemented or provided through a single file serving machine only. For example, in other embodiments of the present invention, the archiving software employed may work with the hard disks or hard drives of a number of personal computers networked together, where this collection of hard drives to make up the primary storage system.

Preferably the computer system involved also includes or has access to an archiving information storage system. Such a system may again store information, but may be implemented using computer hardware that is not as responsive or as quick to provide the information stored as the primary storage system discussed above. Such an archiving storage system may preferably be implemented through a system which has a relatively inexpensive and high information density storage capacity. For example, in some embodiments an archiving storage system may employ at least one magnetic tape storage system that must be spooled and wound to the correct location on the tape to retrieve a particular collection of information.

Preferably the software implemented in accordance with the present invention may provide a stand-alone process or application to be run on a computer system. For this stand-alone process the computer software may provide information archiving functions only, and in some embodiments may preferably also provide the facility to retrieve previously archived information. Such software may in effect provide a “plug-in” application for a computer system—irrespective of the operating system run by the computer system or the particular type of file serving architecture employed within the system. The present invention may provide archiving functionality easily, quickly and inexpensively irrespective of the actual platform of the computer system which it is to be deployed in relation to.

In a further preferred embodiment the archiving software provided may be substantially continuously run as a background process of the computer system. The process provided may automatically archive collections of information without any specific actions, requests or commands from users of the computer system. Such a process may preferably be initialised with a set of instructions or parameters regarding how archiving of information should be completed and then left to run without any further human intervention.

This approach substantially limits actual user interaction with the present invention, greatly simplifying the way such software can be used. The process involved simply needs to be set up and run initially by an administrator of the computer system with parameters regarding when information should be archived. This process can then be allowed to run in the background of the computer system without any further instructions or interaction with users.

The present invention is adapted to provide archiving functions for collections of information stored or managed by a computer system. The actual implementation of the computer system and how it operates will determine the form of the information collections employed. For example, in a preferred (and most common) embodiment collections of information may be in the form of computer files. Distinct computer files may collect and record specific types of information that at a later date may need to be archived.

Reference throughout this specification will also be made to the collections of information managed by the software of the present invention being computer files. However, those skilled in the art should appreciate that other forms and types of information collections may also be managed in conjunction with the present invention and reference to the above only throughout this specification should in no way be seen as limiting.

Reference throughout this specification will also be made to the files to be archived being stored at a particular memory location and being transferred from such an original memory location when archived. Preferably a standard file directory organisational system may be implemented within either the primary or archiving information storage systems to give a specific location where information is or could be stored. When transferred such files can be removed from the particular directory involved and transfer to an alternative directory within the archiving information storage system.

In a preferred embodiment each of the files which potentially could be archived using the present invention may include or have associated at least one attribute. An attribute may form any type of value or parameter associated with the file which can in turn be used to determine whether the file should be archived. For example, files to be archived can have attributes which include creation time, time last modified or accessed, size, name, type, storage location or path. Other attributes assigned to a file and also incorporate specific user defined attributes for the files such as a category or a series of key words which a user has identified with the file.

Preferably an attribute or attributes of the file may be tested by the archiving software to determine whether the file should be archived. To perform such a test or tests one or more rules may be set up by an administrator of the computer system or by a collection of users who are likely to require access to the files stored within a primary storage system. Such a rule or rules may simply test for a threshold value or parameter linked to an attribute of the file. For example, in one instance a rule may be set up to ensure that any files created in excess of six months from the present date are archived. Furthermore, particular attributes of a file may also indicate that the file is not to be archived in any circumstances. This type of rule, when used in combination with other rules, can ensure that important files or other types of information collections are never archived.

Those skilled in the art should appreciate that any number and range of rules may be set up for use in conjunction with the present invention depending on the particular requirements of a computer system's users. This configuration of the present invention effectively automates archiving processes, freeing up the time of computer system administrators for other tasks.

Preferably, the software employed may traverse a directory structure or file structure which has been nominated for monitoring by the archiving software employed. Specific directories only or sections of such a file system can be monitored, with the contents of each directory or folder in the file system being investigated periodically by software employed in conjunction with the present invention. Preferably a directory walking ‘agent’ may be implemented with such software, where such an agent continuously cycles through the directories or folders within the area of the file system to be monitored.

In a preferred embodiment, one or more rules employed in conjunction with the present invention may test a threshold value associated with an attribute of an information collection or file. Such attributes may have preferably a prioritisation, ranking or numeric value which can be compared with a pre-defined threshold.

In a further preferred embodiment at least one rule set up and tested in relation to the software employed may test time specific attributes of a file. Furthermore, a file organisation and directory system set up within the archiving storage system may also be organised along time based lines. For example, a series of directories may be set up within the archiving information storage system which win have archived files located within such directories depending on the date of archiving of the file, or alternatively any time based attributes associated with the file. These time based parameters (either provided as an attribute of the file or determined by the time at which a file is archived) can allow archived information collections or files to be easily searched and subsequently retrieved if required.

For example, in a preferred embodiment directories may be set up for a specific date or a range of dates, with any files archived within these dates being placed in the directory created. In such a scheme, a rule may be set up so that computer files which have a last modified date later than a specific threshold date will be archived. The files which pass this test will be archived and stored in the directory named after the time or date at which archiving occurred.

This type of organisational scheme employed within the archiving information storage system can allow users to easily find any files that have been automatically archived. Furthermore, this type of organisational system also allows summaries dealing with time based information or archived files to be easily prepared simply be investigating the appropriate directories of the archiving information storage system.

Preferably a logging system may also be employed in the completion of such archiving processes. A logging system may record (preferably in a text based computer file) a record of the files archived at any particular point in time from any area of a primary storage system to the archiving information storage system. Alternatively, such a logging system may be adapted to record details of transfers of information collections from the archiving to the primary information storage system if required. Such a logging system may record details of or track the activities of the archiving process to provide, for example, a historical report on the archiving systems activities, or alternatively may be used in a restoration operation in case critical information to the archiving system is lost.

Such a logging system may store a file recording activity on a primary storage system within which the archiving system has been active, or alternatively within the corresponding area of the archiving storage system into which files are transferred. Furthermore, several log files may also be created by such a logging system with a log file being associated in a particular area or partition of the primary storage system, or archiving storage system.

In a preferred embodiment the archiving software employed may also provide a user or administrator interface facility. For example, in a preferred embodiment a web page based interface may be provided to allow an administrator of the computer system or systems involved to program the archiving rules tested by the software provided. This interface facility may allow an administrator of the computer system to control parameters investigated by the software provided, to ensure that the primary storage system does not become overloaded with files users do not necessarily need on a daily basis. Furthermore, such an interface facility can also receive authentication and password information from a system administrator to allow the software employed to have access- to the portions of the file system from which files would be removed when archived. This authentication information may also be encrypted to ensure that unauthorised persons do not also gain access to the file system without the authority of the system administrator.

In a preferred embodiment a file selected for archiving may be compressed prior to storage within the secondary storage system. Compression of files will reduce the size of same and thereby effectively extend the storage capacity of the secondary storage system. As archived files may not necessarily be required frequently or quickly, compression of these files is appropriate for long-term storage.

In a further preferred embodiment files may also be encrypted in the archiving process. Encryption of the information contained within files prevents unauthorised access of this information while stored on or in the secondary storage system. An encryption algorithm may be applied so that only a system administrator or the user or owner of the file can subsequently decrypt same when the file is restored or retrieved from archiving.

In a further preferred embodiment the archiving software employed may also store reference stub information within the location of the primary information storage system from which a file is removed and archived from. Such reference stub information may preferably take the form of another file which incorporates further information regarding the location within the archiving information storage system at which the archived file is stored.

Furthermore, the name of such a stub file can also indicate to a user that a file has been archived and potentially may also indicate the time of archiving of the file. Such a stub file may also provide specific information as to a path or directory structure within the archiving information storage system at which the archive file has been stored.

In a further preferred embodiment the information archiving software may also provide a retrieval function which can be employed by a user to retrieve an archived file. Such a retrieval function may employ the information stored within a reference stub. The location information within the stub file can be used to in turn retrieve the archived file and store it again in the original directory of a primary information storage system.

In a further preferred embodiment such a retrieval function may be activated by a user interacting with or opening the reference stub file or information. This in turn may trigger the retrieval functions of the archiving software provided which will indicate to the user that the archived file is being retrieved and will shortly become available. In the execution of such retrieval functions the software may then retrieve the archived file and save it back into its original location within the primary storage system, this being the current location of the reference stub file. Preferably, the reference stub file may also be maintained in the same location to indicate that the restored file had previously been archived and subsequently restored or retrieved.

In such instances the operation of the retrieval functions are triggered directly by the user of the present invention. Simply through opening the reference stub file or information a user may trigger operation of the archiving function, without directly having to issue commands to a file server system associated with the computer system. Software employed to implement the present invention may run independent from such central file service systems, allowing the present invention to be configured as a stand alone or “plug in” application with any number of different types of computer system platforms and file server environments. This configuration of the invention also allows for full end-user control of the restoration process. A user may both select a file, for restoration and subsequently trigger the restoration process required themselves, thereby freeing up the time of the computer system's administrators and technicians from archive restoration tasks.

The present invention provides many potential advantages over the prior art.

Information or file archiving functionality may be provided inexpensively using a single software application which can operate independent of the operating system or file server architecture of the computer system involved.

Furthermore, such archiving software may operate with an absolute minimum of user interaction and may simply be set up as a background process which permanently runs within the computer system to archive selected files or other information collections.

In addition, archiving software substantially as described above can also be used to easily and quickly retrieve archived files. Reference stub information left behind by the archiving system can be used to firstly indicate that a file has been archived, and then in turn retrieve the archived file if required by a user.

Furthermore, the implementation of the archiving software described above should provide security for the information being archived. The software employed to retrieve an archive file can only be triggered through association with the reference stub file or information. This feature of the invention means that only those authorised to review the original information which was archived will subsequently have access to a reference stub file, thereby restricting the ability of others to retrieve archived information or files.

### BRIEF DESCRIPTION OF DRAWINGS

Further aspects of the present invention will become apparent from the ensuing description which is given by way of example only and with reference to the accompanying drawings in which:

FIGS. 1a and 1b show schematic diagrams of file and directory representations employed by a computer system running archiving software formed in a preferred embodiment where a file is archived; and

FIGS. 2a, 2b and 2c show schematic diagrams of file and directory representations of a computer system running software of a preferred embodiment where a file is retrieved from an archive, and

FIG. 3 shows a schematic flow chart of processes executed and information flows completed in an archiving process performed in accordance with one embodiment, and

FIG. 4 shows a block schematic diagram of processes executed and information flows completed in an retrieval process performed in accordance with one embodiment, and

FIG. 5 shows a schematic diagram of computer hardware deployment and the networking of a computer system which employs the archiving software of the present invention.

### BEST MODES FOR CARRYING OUT THE INVENTION

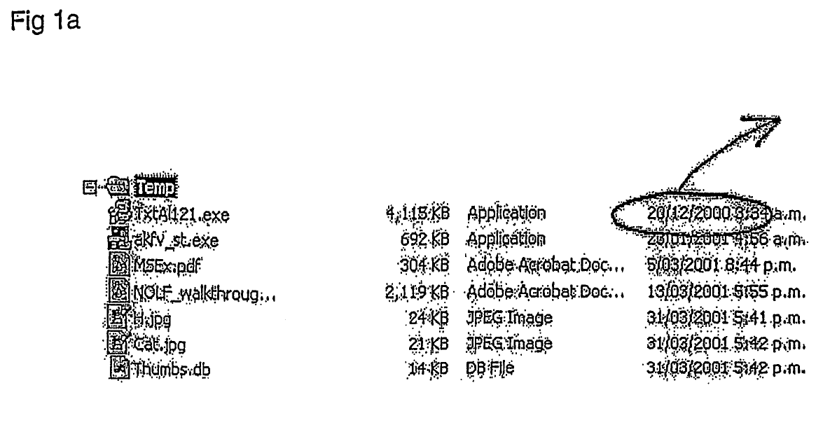

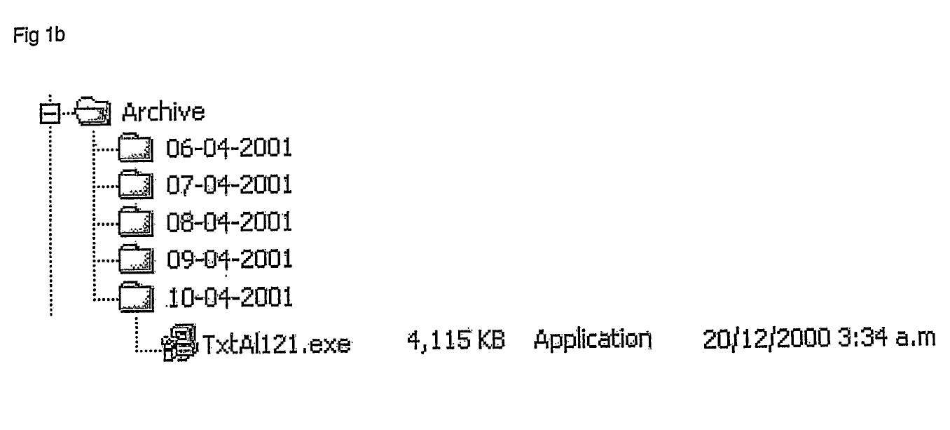

FIGS. 1a and 1b show diagrammatic representations of files and directories structures employed within a computer system. Such a computer system is loaded with information archiving software formed in accordance with a preferred embodiment of the present invention. FIGS. 1a and 1b show the changes in the files stored in two separate memory locations triggered by the archiving of a selected file by such archiving software.

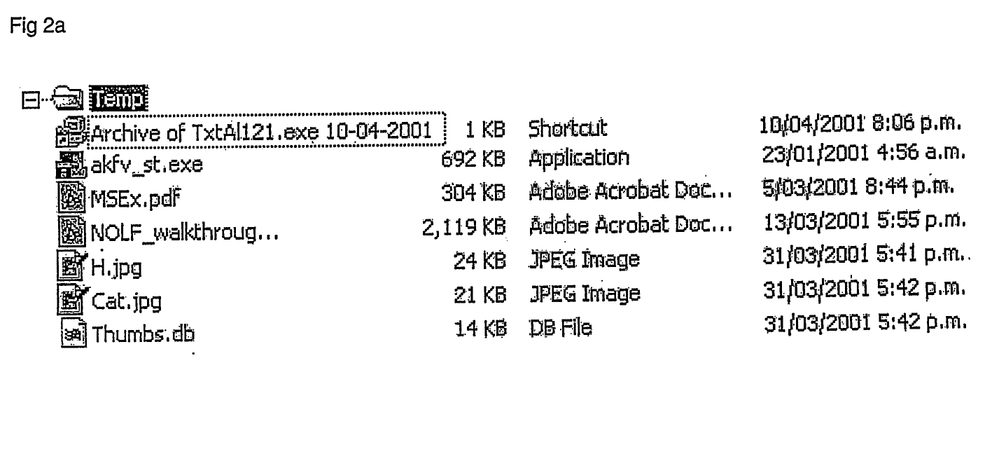

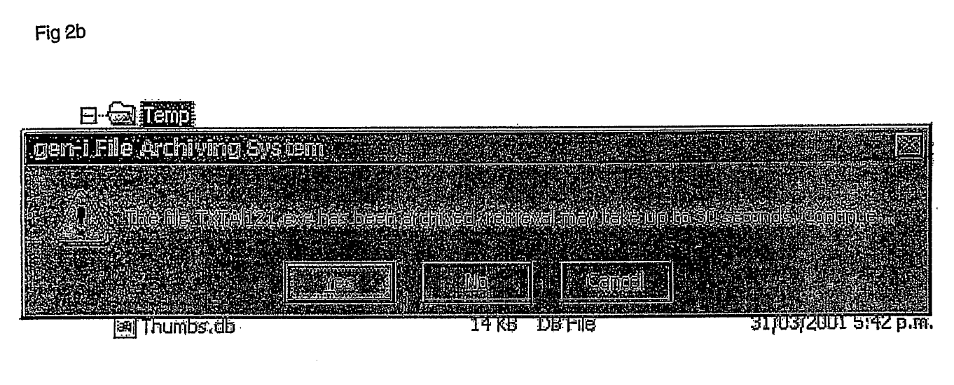

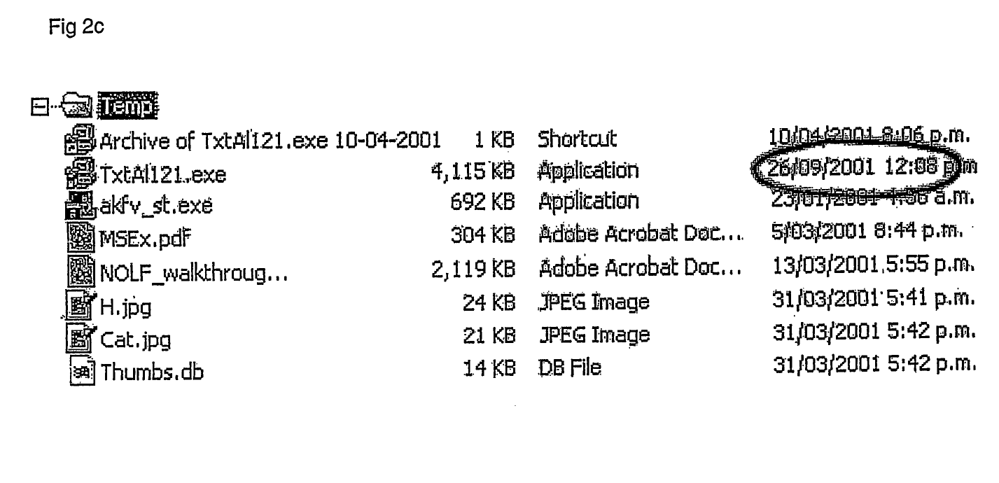

FIGS. 1 and 2 show a computer system running the Windows 2000™ operating system. Those skilled in the art should appreciate that the present invention may be deployed on other types of operating system and it could also be employed in systems running a number of different central file server architectures. Furthermore, if required the present invention could also be employed within a stand alone personal computer to archive files from a hard drive with a long term archiving storage system such as optical media burnt with a CD writing drive.

FIG. 1a shows a number of files stored within a directory of a primary information storage system associated with a computer system. This primary information storage system may preferably be high capacity hard drive administered by file server system within a local area network. The primary information storage system can provide fast access to the files stored within the temp directory shown.

Archiving software provided in accordance with a preferred embodiment of the present invention may be run as a background process within such a computer system. This process can periodically and automatically test particular attributes of the files stored to determine whether these files should be archived. Passing the test applied will result in a file being archived.

FIG. 1a illustrates the case where the file “TxtAll21.exe” is identified as having last been modified on 20 Dec. 2000. This particular modification time attribute of the file is then compared to a rule or test initialised within the software employed. In the instance shown the software will archive any files when the file modification date attribute is tested have a modification date earlier than 1 Jan. 2001. In the instance shown the only file present within the temp directory which passes this test is the “TxtAll21.exe” file, which is selected for archiving.

FIG. 1b shows a directory structure implemented within an archiving information storage system also accessible to the computer system involved. The archive has a number of sub-directories named after specific dates so that duplicate copies of the same file archived at different times are not stored within the same directory. Archived files will be stored in particular directories based on the date which the file was archived on. In the instance shown the archived file from the primary information storage system is transferred to the sub-directory 10-04-2001 of the archive directory within the archiving storage system. This information storage system may retain such historical files using high information density low cost computer hardware, which need not necessarily provide fast access to the information archive.

The archiving process provided as discussed above can be employed to improve the speed at which computer systems can be redeployed or reinstated after a major crash. As the archiving functions provided by the present invention allow the size of the primary information storage system to be substantially reduced, this in turn significantly reduces the time required to reinstate and place back on line such a primary information storage system. This can have major advantages in large computer systems which need continuous access to time sensitive information or files.

FIGS. 2a, 2b and 2c show similar views of directory structures and files, and also a user interface selection window displayed to a user of a system when an archived file needs to be retrieved.

FIG. 2a shows the directory of FIG. 1a after the “TxtAll21.exe” file has been archived. The file involved has been removed from the temp directory and the archiving software has stored in the same directory a reference stub file indicating that the original file has been archived and the date of archiving of this file. The attributes of this reference stub file also indicate that it provides a “shortcut” reference to the new archive storage location of the original archive file.

FIG. 2b shows a screen view from the computer system involved where a user of the system has opened or double clicked on the reference stub file in an attempt to execute the file restoration functionality of the archiving software. Once a user opens or triggers the stub file the initial pop up response window shown with respect to FIG. 2b is displayed, indicating to the user that the file they requested has been archived and may take some time to retrieve. If the user then indicates that they still wish to proceed with the retrieval action the software employed then executes the retrieval of the archived file from the archiving information storage system.

FIG. 2c shows the state of the primary information storage system temp directory once the retrieval function has been completed. The original “TxtAll21.exe” file has been restored to the primary information storage system and has also had its date at last modification updated to the present date, being the time at which this file was retrieved from the archive.

This configuration of retrieval functions provides a degree of security to the information being archived. The retrieval functions are triggered through opening or activation of the stub file which the original owner of the information archived has access to. Therefore, the archived file involved can only be retrieved by standard users who also have access to the reference stub file. By restricting access to the reference stub file, access is in turn restricted to the archived information stored within the archiving information storage system.

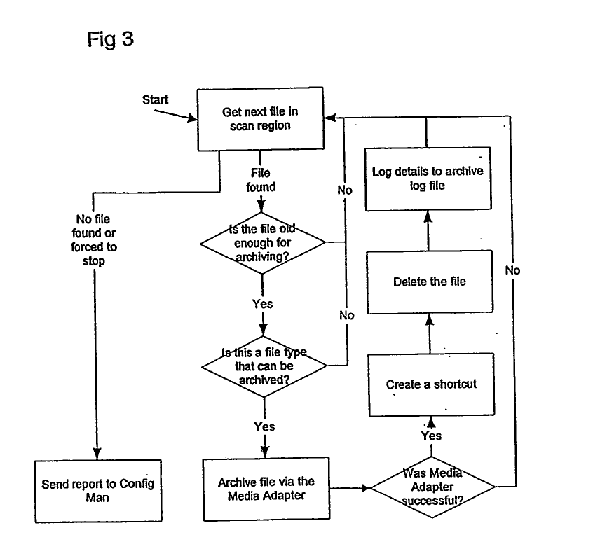

FIG. 3 shows a schematic flow chart of processes executed and information flows completed in an archiving process performed in accordance with one embodiment of the present invention.

As shown with respect to FIG. 3 the software employed is initially started and walks through or inspects each file within a primary storage system to be scanned. If no files are found, or if the software is terminated, a report is generated of the activities and software.

If a file is found the age of the file is checked, as is the file type. A determination is made to see if the file type can be archived or if the file is old enough for archiving. If these two criteria are not satisfied the software employed moves on to the next file in the primary storage structure to be scanned. Otherwise, an archiving process is completed by a further software module defined as a media adapter.

The media adapter module employed operates to move the file involved from the primary storage system and transfer it to an archiving file storage system. Once this process is completed a test is determined to see whether the media adapter software was successful in the archiving process. If the process was successful, a shortcut to the successfully archived file is placed in the primary storage system and the original file is deleted. A logging file detailing the activities of the software is also updated. The software will next proceed on to the next file in the primary storage system to be scanned.

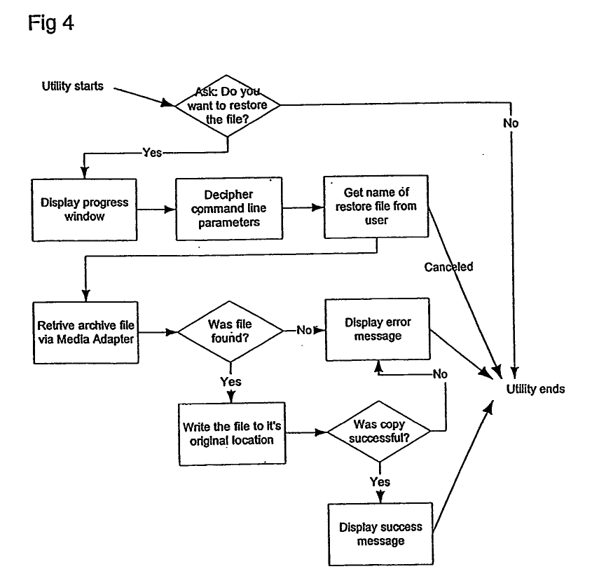

FIG. 4 shows a block schematic diagram of processes executed and information flows completed in a retrieval process performed in accordance with a further embodiment of the present invention.

In the embodiment shown the software employed is triggered through a user opening a reference sub-file or shortcut file, as discussed with respect to FIGS. 1 and 2. After this file has been opened the software employed seeks confirmation from a user that they wish to restore or retrieve the file in question from the archiving system.

Once confirmation is received from the user a progress window is displayed and the reference information from the archived file is extracted from the shortcut file stored in the primary storage directory.

A media adapter software module is next employed to retrieve the archived file using the information stored in the reference or shortcut file. If the media adapter does not find the required archived file, an error message is displayed to the user, and the software finishes executing. Alternatively, if the correct file is found the media adapter retrieves and saves this file to the correct position in the primary storage system.

If this retrieval and saving operation is completed successfully, this is indicated to the user—whereas if an error occurs an error message is displayed to the user. In both instances the software employed then finishes executing.

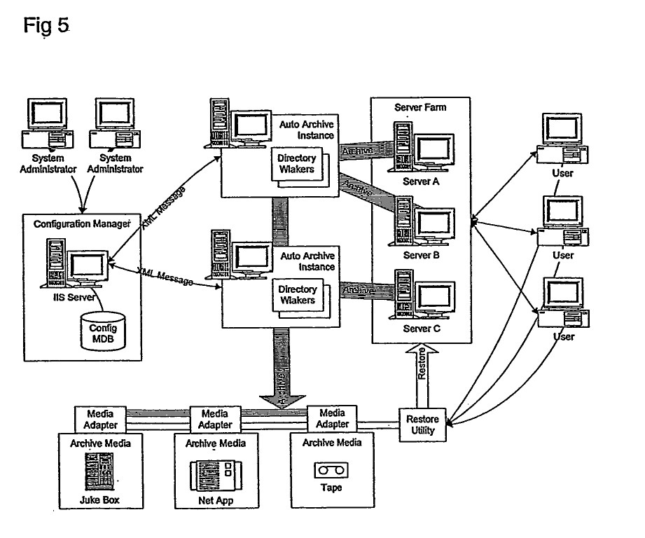

FIG. 5 shows a schematic diagram of computer hardware deployed and networking used in a computer system which employs the archiving software of the present invention.

The primary storage system within which the archiving software operates is provided by the server farm, through servers A, B and C. These servers are linked to and accessible by a number of discrete users. The archive functions of the software employed are executed by the auto archiving machines shown, which run sets of “Directory Walkers” through the primary information storage directories of the servers.

The archiving machines are also in communication with a configuration management system and associated configuration database which is in turn accessed by the terminals of system administrators responsible for the operation of the archiving software. The configuration manager can be used by the system administrators to modify or change the behaviour of the directory walkers and auto archiving software.

The auto archiving machines and associated directory walker software implement the flow chart of operations shown with respect to FIG. 3. Each of the selected directory structures of the servers is inspected for files to be archived by the directory walker. Once a file is found which qualifies for archiving, media adapter software associated with a specific type of archiving storage system (such as an optical CD juke box, a Internet storage system or magnetic tape storage system) is contacted and employed to store or archive the file involved.

The media adapters employed are also directly linked to a restoration software or utility which is triggered or operated by the users connected to the server farm. The restoration utility will execute the processes or operations shown with respect to FIG. 4 to retrieve a file which was previously archived on request from a user. The restoration utility operates in combination with the appropriate media adapter in the server farm to restore the file involved to its original location within the appropriate server.

Aspects of the present invention have been described by way of example only and it should be appreciated that modifications and additions may be made thereto without departing from the scope thereof as defined in the appended claims.

1. Information archiving software for a computer system, said computer system having access to at least one primary information storage system, and an archiving information storage system, the information archiving software being adapted to execute the steps of;
(i) determining at least one attribute of collections of information stored within a primary information storage system and
(ii) testing the attribute or attributes of the collections of stored information within the primary information storage system against at least one pre defined rule, and
(iii) transferring information collections with associated attributes which pass said at least one test from the primary information storage system to the archiving storage system, wherein said information archiving software is implemented as a stand-alone computer application or process independent of any file serving functionality.

2. Information archiving software as claimed in claim 1 wherein said software is adapted to provide a program run substantially continuously by said computer system.

3. Information archiving software as claimed in claim 1 wherein said software is implemented as a stand-alone plug-in application for an existing operating system.

4. Information archiving software as claimed in claim 1 wherein the primary storage system is formed from at least one hard disk drive provided within a central file serving computer system.

5. Information archiving software as claimed in claim 1 wherein the archiving information storage system employs at least one magnetic tape storage system.

6. Information archiving software as claimed in claim 1 wherein attributes of collections of stored information include any one of or combination of creation time, time last modified, time last accessed, size, name, type, storage location and/or assigned key words.

7. Information archiving software as claimed in claim 1 wherein a threshold value associated with an information collection attribute is tested by a predefined rule.

8. Information archiving software as claimed in claim 7 wherein at least one time specific attribute is tested to determine whether an information collection is to be archived.

9. Information archiving software as claimed in claim 1 wherein information collections stored within the archiving information storage system are organised based on time based parameters.

10. Information archiving software as claimed in claim 1 which includes a logging system adapted to record details of transfers of information collections from the primary to the archiving information storage system.

11. Information archiving software as claimed in claim 1 wherein which includes a logging system adapted to record details of transfers of information collections from the archiving to the primary information storage system.

12. Information archiving software as claimed in claim 1 wherein the logging system records details of transfers of information collections from selected areas only of said primary or archiving storage systems.

13. Information archiving software for a computer system, said computer system having access to at least one primary information storage system and an archiving information storage system, the information archiving software being adapted to execute the steps of,
(i) determining at least one attribute of collections of information stored within a primary information storage system, and
(ii) testing the attribute or attributes of the collections of stored information within the primary information storage system against at least one pre defined rule, and
(iii) transferring information collections with associated attributes which pass said at least one test from the primary information storage system to the archiving storage system,
(iv) storing reference stub information within the location of the primary information storage system from which the information collection was removed, said reference stub information indicating the location within the archiving information storage system where the transferred information is stored,
wherein said information archiving software is implemented as a stand-alone computer application or process independent of any file serving functionality.

14. Information archiving software as claimed in claim 13 further characterised by the additional subsequent step of,
(v) activating retrieval functions which employ the stored reference stub information to retrieve and restore an archived information collection to its original storage location within a primary information storage system.

15. Information archiving software as claimed in claim 13 wherein reference stub information indicates the time at which the information collection was transferred to the archiving storage system.

16. Information archiving software as claimed in claim 13 wherein user interaction with stored reference stub information causes the transfer of the archived information collection to the location of said reference stub information from the archiving information storage system.

17. Information archiving software substantially as herein described with reference to and as illustrated by the accompanying drawings and/or examples.

18. A method of providing an information archiving facility for a computer system substantially as herein described with reference to and as illustrated by the accompanying drawings and/or examples.
